(19) United States
(12) Patent Application Publication
(10) Pub. No.: US 2014/0324810 A1
(43) Pub. Date: Oct. 30, 2014

(54) INTERNET ACCESSING METHOD AND DEVICE, MOBILE TERMINAL AND STORAGE MEDIUM

(71) Applicant: TENCENT TECHNOLOGY (SHENZHEN) COMPANY LIMITED, Shenzhen (CN)

(72) Inventors: Zhipei WANG, Shenzhen (CN); Bo HU, Shenzhen (CN); Tingyong TANG, Shenzhen (CN); Renfang LIU, Shenzhen (CN); Ruiyi ZHOU, Shenzhen (CN); Xi WANG, Shenzhen (CN); Zhengkai XIE, Shenzhen (CN); Bosen HE, Shenzhen (CN); Ying HUANG, Shenzhen (CN); Wei LI, Shenzhen (CN); Cheng FENG, Shenzhen (CN); Kai ZHANG, Shenzhen (CN); Huijiao YANG, Shenzhen (CN); Yulei LIU, Shenzhen (CN)

(21) Appl. No.: 14/324,518

(22) Filed: Jul. 7, 2014

Related U.S. Application Data
(63) Continuation of application No. PCT/CN2013/090900, filed on Dec. 30, 2013.

(30) Foreign Application Priority Data
Mar. 25, 2013 (CN) 201310097950.6

(51) Int. Cl. G06F 17/30

(52) U.S. Cl. CPC G06F 17/30867
USPC 707/706

(57) ABSTRACT

The invention discloses an Internet accessing method and device, a mobile terminal and a storage medium, and the method comprises: shooting and obtaining an image showing target characters; recognizing and obtaining contents of the target characters shown in the image; an accessing the Internet according to the contents of the target characters. In the present invention, the image showing the target characters is obtained through shooting/scanning by the terminal device, and the contents of the target characters can be recognized from the image based on the text recognition technologies, so that the Internet can be automatically accessed according to the obtained contents of the target characters. Therefore, it is possible to automatically access the Internet to obtain related information according to the external text or character information without manual input of the external text or character information by the user or with the manual input of a simple instruction.

### CROSS-REFERENCE TO RELATED APPLICATION

This application claims priority to and is a continuation of PCT/CN2013/090900, filed on Dec. 30, 2013 and entitled “Internet Accessing Method and Device, Mobile Terminal and Storage Medium”, which claims the benefit of Chinese Patent Application No. 201310097950.6, filed with the Chinese Patent Office on Mar. 25, 2013 by Tencent Technology (Shenzhen) Co. and titled “Internet Accessing Method and Device, and Mobile Terminal”, the contents of which are incorporated herein by reference in their entirety.

### FIELD OF THE INVENTION

The present invention relates to the field of Internet technologies, and in particular to an Internet accessing method and device, a mobile terminal and a storage medium.

### BACKGROUND OF THE INVENTION

The technologies for obtaining information through shooting/scanning a two-dimensional bar code have been widely used along with the development of mobile Internet technologies. Particularly, a webpage address used for obtaining the information is usually carried by a two-dimensional bar code to be shot/scanned by a user at present, so that the webpage address may be used conveniently by the user to access the corresponding webpage to obtain the information. Further, obtaining information through a two-dimensional bar code is advantageous for high recognition accuracy.

However, there are also limitations in obtaining information through the two-dimensional bar code, because the corresponding two-dimensional bar code needs to be made in advance according to the information to be shown, so that the application range of such manner of obtaining information through the two-dimensional bar code has been severely limited. Meantime, a large amount of text information and character information faced daily by the user of a terminal device is not provided with any dedicated two-dimensional bar code, in this case, if the user finds an interested webpage address or other information when reading, watching a video, and enjoying an advertisement, the user has to manually input the webpage address to access the webpage or searches for the specific information, which results in a low automatization level and poor accuracy and convenience.

And this section provides background information related to the present disclosure which is not necessarily prior art.

### SUMMARY OF THE INVENTION

In the present invention, an Internet accessing method and device, a mobile terminal and a storage medium are provided to enable conveniently and automatically accessing to the Internet according to text or character information found by a user.

Thus, the following technical solutions are adopted by the present embodiment:

An Internet accessing method includes:
shooting and obtaining an image showing target characters;
recognizing and obtaining contents of the target characters shown in the image;
accessing the Internet according to the contents of the target characters.

An Internet accessing device includes: one or more processors operating in conjunction with a memory and a plurality of units, wherein the plurality of units comprises:
an image obtaining unit, which is configured to shoot and obtain an image showing target characters;
a target character content obtaining unit, which is configured to recognize and obtain contents of the target characters shown in the image; and
an access unit, which is configured to access the Internet according to the contents of the target characters.

A mobile terminal includes the above Internet accessing device.

A storage medium including computer-executable instructions, wherein the computer-executable instructions are configured to perform an Internet accessing method, and the method includes:
shooting and obtaining an image showing target characters;
recognizing and obtaining contents of the target characters shown in the image; and
accessing the Internet according to the contents of the target characters.

### BRIEF DESCRIPTION OF THE DRAWINGS

FIG. 1 is a flow chart of the Internet accessing method according to a first embodiment of the present invention.

FIG. 2 is a flow chart of the Internet accessing method according to a second embodiment of the present invention.

FIG. 3 is a flow chart of the Internet accessing method according to a third embodiment of the present invention.

FIG. 4 is a flow chart of the Internet accessing method according to a forth embodiment of the present invention.

FIG. 5 is a schematic view of showing target characters according to the forth embodiment of the present invention.

FIG. 6 is a schematic view of showing target characters according to the forth embodiment of the present invention.

FIG. 7 is a schematic view showing an Internet accessing device according to a fifth embodiment of the present invention.

### DETAILED DESCRIPTION OF THE EMBODIMENTS

The technical solutions of the present invention will be further described below through embodiments in combination with accompanying drawings.

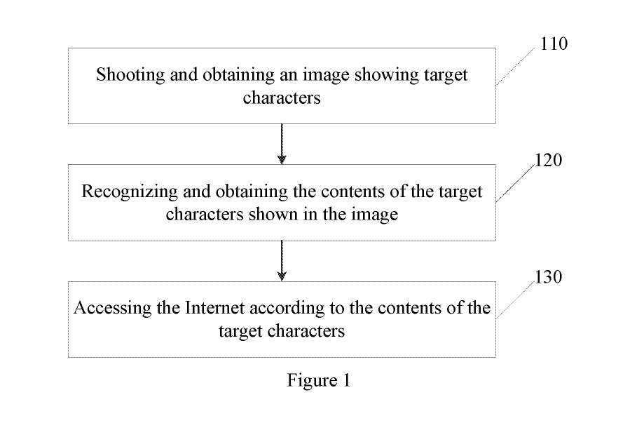

FIG. 1 is a flow chart of the Internet accessing method according to the first embodiment of the present invention. As illustrated in FIG. 1, the method includes steps 110-130 below.

At step 110, an image showing target characters is shot and obtained.

The obtained image showing the target characters either contains only target character(s) or contains other text information in addition to the target character(s).

In the present embodiment, the target characters may be a character and/or a combination of characters interested by a user, and the characters can be Chinese characters, letters, symbols and the like.

At step 120, the contents of the target characters shown on the image are recognized and obtained.

Particularly, through a text recognition algorithm, every character in the image can be recognized and extracted after the image is subjected to operations of text positioning, image cutting, rectifying, denoising, character recognizing, and the like. The contents of the target characters are text information corresponding to the target characters. It should be understood by the skilled person in the art that all the existing technologies for recognizing the text in the image as the corresponding text information can be applied to the present embodiment.

At step 130, the Internet is accessed according to the contents of the target characters.

In the step 130 of the method of the present embodiment, it is possible to access the Internet according to the contents of the target characters via a newly started Internet browser or the already-started Internet browser.

In a preferable implementation of the present embodiment, the target characters constitute an IP address or a webpage address. When a user finds an IP address or a webpage address interested, an image showing the IP address or the webpage address is obtained and recognized by a terminal device, to obtain the IP address or the webpage address constituted by the target characters.

Then in the step 130, the IP address or the webpage address as obtained is used as the target address in the Internet browser to access the Internet.

For example, if a user finds a webpage address of http://www.qq.com for a Tencent website on a propaganda poster and wishes to automatically access the corresponding webpage, the user can obtain an image of a part of the propaganda poster that contains the webpage address through a terminal device, so that every character of the webpage address can be recognized and extracted by the terminal device through the operations of text positioning, image cutting, rectifying, denoising, characters recognizing, and the like, and then the recognized webpage address is inputted into an address bar of the started webpage browser to automatically access the webpage address.

Accordingly, the present embodiment allows a user to conveniently and quickly access an interested Internet address when the user finds the Internet address in reading a book or watching a video or image.

In another preferable implementation of the present embodiment, the target characters are keywords for searching. When the user sees an interested keyword, an image showing the keyword information is obtained and recognized by a terminal device, to obtain the keyword constituted by the contents of the target characters.

Then in the step 130, searching based on the obtained keyword is conducted by a default search engine of an Internet browser.

For example, when a user sees a poetry in a magazine and wishes to know information about the writer of the poetry, the user can obtain an image of a part of the magazine that contains a keyword for searching (such as the name of the writer Bai LI) through a terminal device, so that every character of the keyword for searching is recognized and extracted by the terminal device through the operations of text positioning, image cutting, rectifying, denoising, character recognizing, and the like, and then the recognized keyword is inputted into a search bar of the started web browser to automatically search information based on the keyword.

Accordingly, the present embodiment allows a user to conveniently and quickly search for information when the user finds any interested information in reading a book or watching a video or image.

In the present embodiment, the image showing the target characters is obtained through shooting/scanning by the terminal device, and the contents of the target characters can be recognized from the image showing the target characters based on the text recognition technologies, so that the Internet can be automatically accessed according to the obtained contents of the target characters. Therefore, it is possible to automatically access the Internet to obtain related information according to the external text or character information without manual input of the external text or character information by the user.

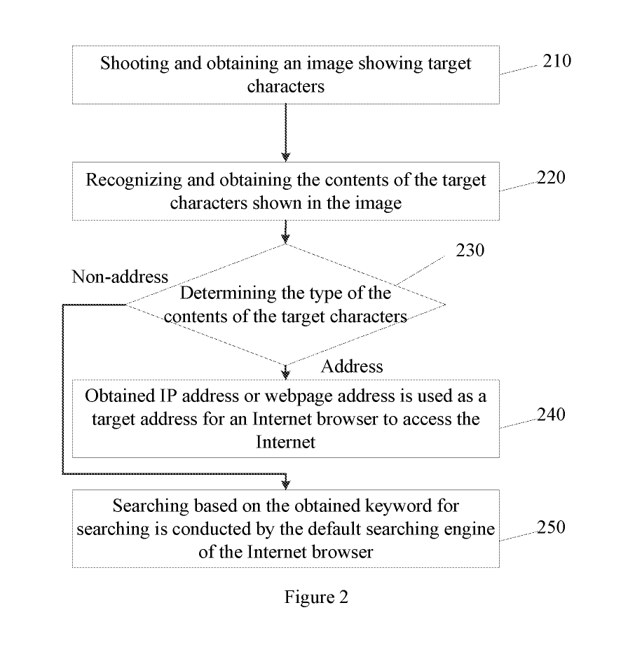

The first embodiment of the present invention implements the automatic access to or search for a certain type of information, not multiple types of information. The second embodiment of the present invention aims to automatically process various types of external information. FIG. 2 is a flow chart of the Internet accessing method according to the second embodiment of the present invention. As illustrated in FIG. 2, the method includes steps 210-250 below.

At step 210, an image showing target characters is shot and obtained.

At step 220, the contents of the target characters shown in the image are recognized and obtained.

At step 230, the type of the contents of the target characters is determined, and if the contents of the target characters constitute an IP address or a webpage address, the step 240 is executed; and if the contents of the target characters constitute non-address information, the step 250 is executed.

Particularly, after the contents of the target characters are obtained, it is determined whether the contents of the target characters constitute address information according to the initial part of the string of the characters. For example, if the initial part of the string of the characters contains a protocol type and a corresponding delimiter, such as http://, or www, it is determined that the contents of the target characters constitute the address information. Of course, it can be understood by the skilled person in the art that all the technologies used for further discriminating the characters to determine whether the characters indicate the accessible IP address or webpage address can be applied to this step.

At step 240, the obtained IP address or webpage address is used as the target address of an Internet browser to access the Internet.

At step 250, searching based on the obtained keyword for searching is conducted by the default searching engine of the Internet browser.

Accordingly in the present embodiment, through the additional step of determining the type of the contents of the target characters, the address information can be automatically inputted into the address bar of the webpage browser to access the Internet, and the non-address information can be automatically inputted into the searching bar of the Internet browser for the purpose of searching, so that the external information can be adaptively processed, to enable the user to conveniently and quickly access the Internet based on any external information.

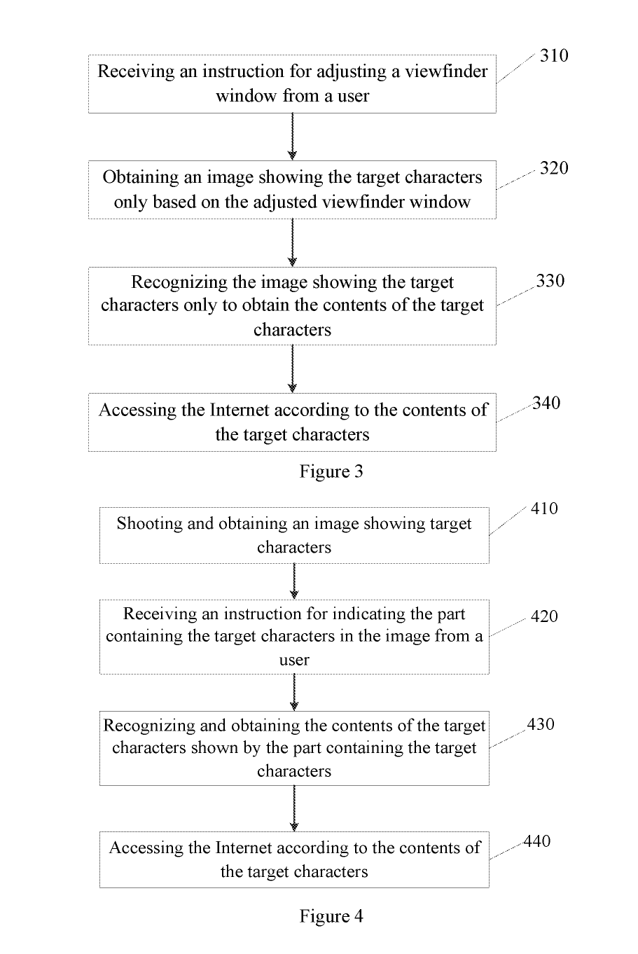

FIG. 3 is a flow chart of the Internet accessing method according to the third embodiment of the present invention. As illustrated in FIG. 3, the method includes steps 310-330 below.

At step 310, an instruction for adjusting a viewfinder window is received from a user.

For example, if the user is interested in the webpage address of a Tencent website in a propaganda poster, the size of the viewfinder window can be adjusted so that only the webpage address http://www.qq.com of the Tencent website is shown in the viewfinder window to obtain the appropriate image.

At step 320, the image showing the target characters only is obtained based on the adjusted viewfinder window.

Accordingly, the image which shows the target characters only but not any redundant information is shot and obtained by the terminal device through the adjustment of the viewfinder window by the user, thus the noise in the following text recognizing phase can be reduced and the operations in the recognizing phase are simplified.

At step 330, the image showing the target characters only is recognized to obtain the contents of the target characters.

Particularly, through a text recognition algorithm, every character in the image can be recognized and extracted after the image is subjected to operations of text positioning, image cutting, rectifying, denoising, character recognizing, and the like. The contents of the target characters are text information corresponding to the target characters. It should be understood by the skilled person in the art that all the existing technologies for recognizing the text in the image as the corresponding text information can be applied to the present embodiment.

At step 340, the Internet is accessed according to the contents of the target characters.

Optionally, the contents of the target characters are then processed in the same way as in the first embodiment, for example, the contents of the target characters are inputted into an address bar of the webpage browser to access the Internet, or the contents of the target characters are inputted into a searching bar of the webpage browser to conduct searching and accessing via the default searching engine.

Optionally, as illustrated in the second embodiment, after the type of the contents of the target characters is determined, the address information and the non-address information are processed differently.

In the present embodiment, only the target characters are shown in a viewfinder window under an instruction of adjusting the viewfinder window received from the user, and in the following steps of text recognizing, all of the texts in the image are considered by default as the target characters, which are then recognized for the Internet access, to simplify the steps of text recognizing, ensure the quality of the obtained image showing the target characters, and further increase the precision and the accuracy of the Internet access.

FIG. 4 is a flow chart of the Internet accessing method according to the forth embodiment of the present invention. As illustrated in FIG. 4, the method includes steps 410-440 below.

At step 410, an image showing target characters is shot and obtained.

The obtained image showing the target characters either contains only target character(s) or contains other text information in addition to the target character(s).

At step 420, an instruction for indicating a part of the image showing the target characters is received from the user, where the part of the image includes the target characters.

When redundant information is shown in the obtained image showing the target characters, the interested part of the image (i.e. the part of the image includes the target characters) can be indicated through the operation by the user.

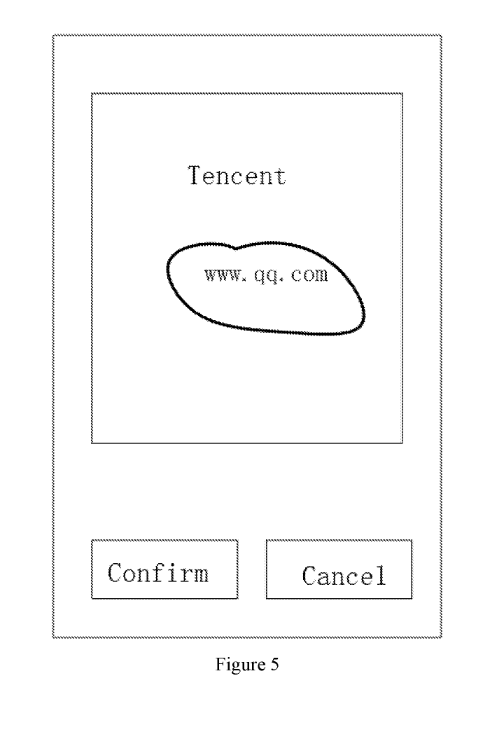

Particularly, the part containing the target characters in the image can be obtained according to an instruction for circling the target characters that is inputted by the user through touching. As illustrated in FIG. 5, the obtained image contains other information besides the webpage address of www.qq.com interested by the user, in this case, the part containing the target characters in the image can be indicated by the user through the instruction for circling the interested webpage address, which is inputted by a touch panel device.

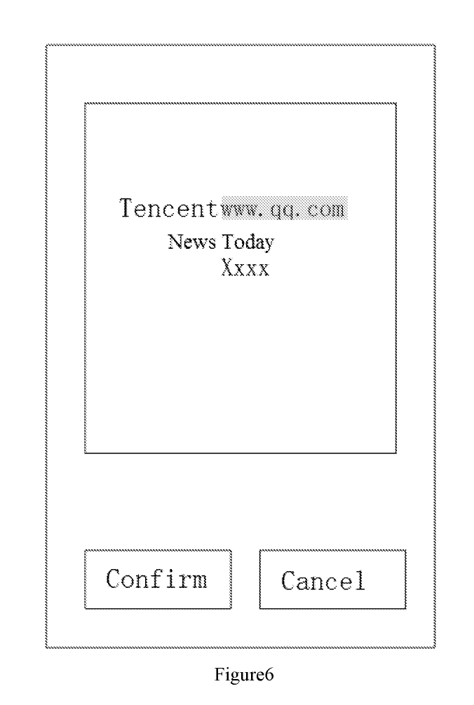

By virtue of the horizontal arrangement of the text, a cursor with a predetermined width is slid, and the area travelled by the slid cursor is utilized to select the part containing the target characters in the image. As illustrated in FIG. 6, the obtained image contains other information besides the webpage address of www.qq.com interested by the user, in this case, the user can slide translationally the cursor with a certain width through the touch panel device, and the area (i.e. the gray area as shown) travelled by sliding the cursor is the area interested by the user.

At step 430, the contents of the target characters shown in the part containing the target characters are recognized and obtained.

In this step, the part containing the target characters that is indicated by the user is extracted and subjected to text recognizing, to obtain the contents of the target characters.

At step 440, the Internet is accessed according to the contents of the target characters.

Optionally, the contents of the target characters are then processed in the same way as in the first embodiment, for example, the contents of the target characters are inputted into an address bar of the webpage browser to access the Internet, or the contents of the target characters are inputted into a searching bar of the webpage browser to conduct searching and accessing via the default searching engine.

Optionally, as illustrated in the second embodiment, after the type of the contents of the target characters is determined, the address information and the non-address information are processed differently.

In the present embodiment, the instruction for indicating the target characters is received from the user in the stage of text recognizing, to overcome the defect of dissatisfying access caused by the existence of the redundant information in the obtained image.

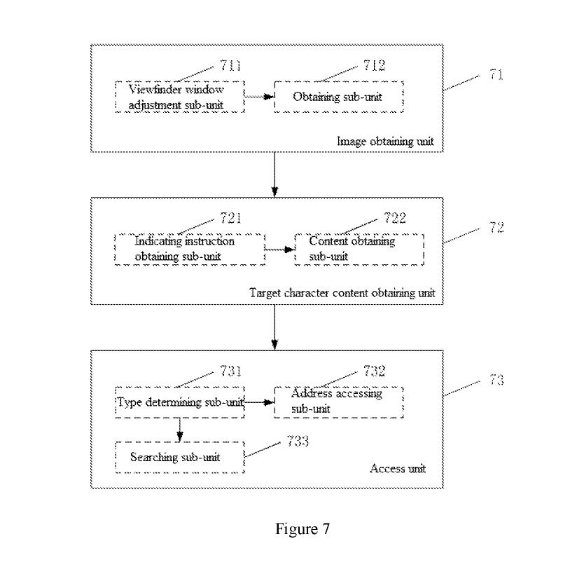

FIG. 7 is a schematic view showing an Internet accessing device according to the fifth embodiment of the present invention. As illustrated in FIG. 7, the device includes: one or more processors operating in conjunction with a memory and a plurality of units, wherein the plurality of units comprises: an image obtaining unit 71, a target character content obtaining unit 72 and an access unit 73.

The image obtaining unit 71 is configured to shoot and obtain an image showing the target characters. The target character content obtaining unit 72 is configured to recognize and obtain the contents of the target characters shown in the image. The access unit 73 is configured to access the Internet according to the contents of the target characters.

In a preferable implementation of the present embodiment, the access unit 73 is configured to access the Internet by utilizing the obtained contents of the target characters as the target address for the webpage browser.

In a preferable implementation of the present embodiment, the access unit 73 is configured to conduct searching in the default engine of the webpage browser by utilizing the recognized and obtained contents of the target characters as a keyword for searching.

In a preferable implementation of the present embodiment, the access unit 73 is configured to discriminate the types of the target characters, and function differently depending upon the type of the target characters. Particularly, the access unit 73 includes:
a type determining sub-unit 731, which is configured to determine the type of the contents of the target characters;
an address accessing sub-unit 732, which is configured to, when the contents of the target characters are determined as an IP address or a webpage address, access the Internet by utilizing the IP address or webpage address as the target address for the webpage browser; and
a searching sub-unit 733, which is configured to, when the contents of the target characters are determined as a non-address character string, conduct searching in the default engine of the Internet browser by utilizing the contents of the target characters as the keyword for searching.

Accordingly in the present embodiment, through the additional step of determining the type of the contents of the target characters, the address information can be automatically inputted into the address bar of the webpage browser to access the Internet, and the non-address information can be automatically inputted into the searching bar of the Internet browser for the purpose of searching, so that the external information can be adaptively processed, to enable the user to conveniently and quickly access the Internet based on any external information.

In another preferable implementation of the present embodiment, for the device, the image which shows the target characters only but not any redundant information is shot and obtained by the terminal device through the adjustment of the viewfinder window by the user, thus the noise in the following text recognizing phase can be reduced and the operations in the recognizing phase are simplified. In the present embodiment, the image obtaining unit 71 includes:
a viewfinder window adjustment sub-unit 711, which is configured to receive an instruction for adjusting the viewfinder window from the user; and
an obtaining sub-unit 712, which is configured to obtain an image showing the target characters only based on the adjusted viewfinder window.

In another preferable implementation of the present embodiment, when redundant information is shown in the obtained image showing the target characters, the interested part of the image (i.e. the part of the image includes the target characters) can be indicated through the operation by the user. Particularly, the target character content obtaining unit 72 includes:
an indicating instruction obtaining sub-unit 721, which is configured to receive an instruction for indicating the part containing the target characters in the image from the user; where, the instruction is an instruction for circling the part containing the target characters in the image showing the target characters, or an instruction for selecting the part containing the target characters in the image by a cursor; and
a content obtaining sub-unit 722, which is configured to obtain the contents of the target characters according to the indicated part containing the target characters.

The Internet accessing device in the present embodiment can be embedded in the mobile terminal as a software or hardware controller, to enable he mobile terminal to conveniently access the Internet by utilizing the Internet accessing device.

In the present embodiment, the image showing the target characters is obtained through shooting/scanning by the terminal device, and the contents of the target characters can be recognized from the image showing the target characters based on the text recognition technologies, so that the Internet can be automatically accessed according to the obtained contents of the target characters. Therefore, it is possible to automatically access the Internet to obtain related information according to the external text or character information without manual input of the external text or character information by the user or with the manual input of a simple instruction.

Apparently, it should be understood by the skilled person in the art that, each of the above units or steps in the present invention can be implemented integratedly by a single universal computing apparatus or distributedly on a network constituted by several computing apparatuses, alternatively implemented by the computer-executable program codes which may be stored into a memory device and executed by a computer, alternatively formed into an integrated circuit module, or several of the above units or steps are formed into a single integrated circuit module. Therefore, the present invention is not limited to the specific combination of hardware and software.

An embodiment of the present invention further provides a computer-readable storage medium comprising computer-executable instructions, which are configured to perform an Internet accessing method, and the method includes:
shooting and obtaining an image showing target characters;
recognizing and obtaining the contents of target characters shown in the image; and
accessing the Internet according to the contents of the target characters.

It should be understood by the skilled person in the art in light of the description of the above embodiments that, the present invention can be embodied by software and the necessary universal hardware, or merely hardware, but mostly the former is a preferable embodiment. Based on this understanding, the technical solution of the present invention may be substantially embodied in a software product or a part of the technical solution that contributes to the prior art may be embodied in a software product, and the computer software can be stored in the storage medium which may be a floppy disk, a Read-only Memory, a Random Access Memory, a Flash, a hard disk, an optical disk and the like, instructions included in the software product are used to enable the computer device (such as a personal computer, a server or a network device) to execute the method described in the embodiments of the present invention.

Preferable embodiments of the present invention have been described as above, but are not intended to limit the present invention. Various changes and modifications to the present invention are possible to those skilled in the art. Any modification, equivalent alteration and improvement made in the principle of the present invention is included into the protection scope of the present invention.

1. An Internet accessing method, comprising:
shooting and obtaining an image showing target characters;
recognizing and obtaining contents of the target characters shown in the image;
accessing the Internet according to the contents of the target characters.

2. The Internet accessing method according to claim 1, wherein, accessing the Internet according to the contents of the target characters comprises:
accessing the Internet by utilizing the obtained contents of the target characters as a target address for an Internet browser.

3. The Internet accessing method according to claim 1, wherein, accessing the Internet according to the contents of the target characters comprises:
conducting searching in a default searching engine of an Internet browser by utilizing the obtained contents of the target characters as a keyword for searching.

4. The Internet accessing method according to claim 1, wherein, accessing the Internet according to the contents of the target characters comprises:
determining the type of the contents of the target characters;
if the contents of the target characters constitute an IP address or a webpage address, accessing the Internet by utilizing the IP address or webpage address as a target address for an Internet browser; and
if the contents of the target characters constitute non-address information, conducting searching in a default searching engine of an Internet browser by utilizing the contents of the target characters as a keyword for searching.

5. The Internet accessing method according to claim 1, wherein, shooting and obtaining an image showing target characters comprises:
receiving an instruction for adjusting a viewfinder window from a user; and
obtaining the image showing the target characters only based on the adjusted viewfinder window.

6. The Internet accessing method according to claim 1, wherein, recognizing and obtaining the contents of the target characters shown in the image comprises:
receiving an instruction for indicating the part containing the target characters in the image from a user; and
obtaining the contents of the target characters according to the indicated part containing the target characters.

7. The Internet accessing method according to claim 6, wherein, the instruction for indicating the part containing the target characters in the image is an instruction for circling the part containing the target characters in the image, or an instruction for selecting the part containing the target characters in the image by sliding a cursor.

8. An Internet accessing device, comprising: one or more processors operating in conjunction with a memory and a plurality of units, wherein the plurality of units comprises:
an image obtaining unit, which is configured to shoot and obtain an image showing target characters;
a target character content obtaining unit, which is configured to recognize and obtain contents of the target characters shown in the image; and
an access unit, which is configured to access the Internet according to the contents of the target characters.

9. The Internet accessing device according to claim 8, wherein, the access unit is configured to access the Internet by utilizing the obtained contents of the target characters as a target address for a webpage browser.

10. The Internet accessing device according to claim 8, wherein, the access unit is configured to conduct searching in a default engine of a webpage browser by utilizing the obtained contents of the target characters as a keyword for searching.

11. The Internet accessing device according to claim 8, wherein, the access unit comprises:
a type determining sub-unit, which is configured to determine the type of the contents of the target characters;
an address accessing sub-unit, which is configured to, when the contents of the target characters are determined as an IP address or a webpage address, access the Internet by utilizing the IP address or webpage address as a target address for a webpage browser; and
a searching sub-unit, which is configured to, when the contents of the target characters are determined as non-address information, conduct searching in a default engine of an Internet browser by utilizing the contents of the target characters as a keyword for searching.

12. The Internet accessing device according to claim 8, wherein, the image obtaining unit comprises:
a viewfinder window adjustment sub-unit, which is configured to receive an instruction for adjusting a viewfinder window from a user; and
an obtaining sub-unit, which is configured to obtain an image showing the target characters only based on the adjusted viewfinder window.

13. The Internet accessing device according to claim 8, wherein, the target character content obtaining unit comprises:
indicating instruction obtaining sub-unit, which is configured to receive an instruction for indicating the part containing the target characters in the image from the user; and
a content obtaining sub-unit, which is configured to obtain the contents of the target characters according to the indicated part containing the target characters.

14. The Internet accessing device according to claim 8, wherein, an instruction for indicating the part containing the target characters in the image an instruction for circling the part containing the target characters in the image, or an instruction for selecting the part containing the target characters in the image by a cursor.

15. A mobile terminal comprising an Internet accessing device, wherein the Internet accessing device comprises one or more processors operating in conjunction with a memory and a plurality of units, and the plurality of units comprises:
an image obtaining unit, which is configured to shoot and obtain an image showing target characters;
a target character content obtaining unit, which is configured to recognize and obtain contents of the target characters shown in the image; and
an access unit, which is configured to access the Internet according to the contents of the target characters.
